(19) United States
(12) Patent Application Publication
(10) Pub. No.: US 2024/0047124 A1
(43) Pub. Date: Feb. 8, 2024

(54) CLAMPING DEVICE OF STEREOSCOPIC WOUND IRON CORE TRANSFORMER AND TRANSFORMER

(71) Applicant: Haihong Electric Co. Ltd., Jiangmen, Guangdong (CN)

(72) Inventors: Kaixuan Xu, Jiangmen, Guangdong (CN); Qingning Liang, Jiangmen, Guangdong (CN); Jianbo Yang, Jiangmen, Guangdong (CN); Hengzhi Tan, Jiangmen, Guangdong (CN); Jiajun Huang, Jiangmen, Guangdong (CN); Jingnuan Zhang, Jiangmen, Guangdong (CN); Zhuowen Guan, Jiangmen, Guangdong (CN)

(21) Appl. No.: 17/640,040

(22) PCT Filed: Nov. 10, 2021
(86) PCT No.: PCT/CN2021/129879

§ 371 Date: Oct. 13, 2022

(30) Foreign Application Priority Data
Apr. 9, 2021 (CN) 202110383583.0

(51) Int. Cl. H01F 27/30; H01F 27/33

(52) U.S. Cl. CPC H01F 27/303; H01F 27/306; H01F 27/33

(57) ABSTRACT

Disclosed are a clamping device of a stereoscopic wound iron core transformer and a transformer. The clamping device includes a lower frame, a plurality of upper platen assemblies and a plurality of screw assemblies. The lower frame is configured for being arranged at lower sides of a plurality of coil windings of the stereoscopic wound iron core transformer, the plurality of upper platen assemblies are configured for being distributed at upper sides of the plurality of coil windings, and the lower frame and the upper platen assemblies are connected through the screw assemblies, so as to clamp the coil windings together.

### TECHNICAL FIELD

The disclosure relates to the technical field of electric power device, and more particularly, to a clamping device of a stereoscopic wound iron core transformer and a transformer.

### BACKGROUND

Stereoscopic wound iron core transformer is used more and more widely due to the advantages of excellent performance, low no-load loss and low noise level.

In the related art, the stereoscopic wound iron core transformer is usually provided with a clamping device, which is used for supporting coil windings during assembly and operation of the transformer, so as to avoid the coil windings from displacement to affect performance of the transformer, thus increasing no-load loss and noise.

Traditional clamping device mainly includes an upper clamping member and a lower clamping member which are generally regular triangular frames. The upper clamping member and the lower clamping member are formed by welding steel plates or section steels. The upper clamping member and the lower clamping member form a whole around a contour line of an iron core, and the upper clamping member and the lower clamping member are connected through a plurality of screw assemblies, with a large occupied volume, a high weight and a lot of consumables used for manufacturing.

### SUMMARY

The following is a summary of the subject matter described in detail herein. This summary is not intended to limit the scope of protection of the claims.

An embodiment of the disclosure provides a clamping device of a stereoscopic wound iron core transformer and a transformer, which can reduce a volume and a weight of the clamping device, and save consumables.

In a first aspect, an embodiment of the disclosure provides a clamping device of a stereoscopic wound iron core transformer, and the clamping device includes:
a lower frame, wherein the lower frame is configured for being arranged at lower sides of a plurality of coil windings of the stereoscopic wound iron core transformer;
a plurality of upper platen assemblies, wherein the plurality of upper platen assemblies are configured for being distributed at upper sides of the plurality of coil windings; and
a plurality of screw assemblies, wherein the screw assemblies are configured for connecting the lower frame with the upper platen assemblies, so that the lower frame and the upper platen assemblies clamp the coil windings together.

The clamping device according to the embodiment of the disclosure in the first aspect at least has the following beneficial effects.

The clamping device according to the embodiment of the disclosure includes the lower frame, the plurality of upper platen assemblies and the plurality of screw assemblies, wherein the lower frame is configured for being arranged at the lower sides of the plurality of coil windings of the stereoscopic wound iron core transformer, the upper platen assemblies are configured for being distributed at the upper sides of the plurality of coil windings, and the lower frame and the upper platen assemblies are connected through the screw assemblies, so as to clamp the coil windings together. For the clamping device provided by the embodiment of the disclosure, compared with a traditional clamping device, steel consumables around an iron core are reduced, so that the device has a simpler structure, a smaller overall occupied volume, a lower weight, which can save materials and reduce stray loss of the transformer.

According to some embodiments in the first aspect of the disclosure, the plurality of upper platen assemblies include a plurality of first upper platen assemblies, and each of the first upper platen assemblies is configured for being correspondingly distributed at a side of one iron core post of a stereoscopic wound iron core.

According to some embodiments in the first aspect of the disclosure, each of the first upper platen assemblies includes:
a first upper platen; and
a first upper holder block configured for being arranged between the first upper platen and the coil winding.

According to some embodiments in the first aspect of the disclosure, the plurality of screw assemblies include a plurality of first screw assemblies, each of the first screw assemblies is configured for connecting a respective one of the first upper platen assemblies with the lower frame and includes a first tightening screw and a first fastening nut, wherein a lifting member is provided at a top of the first tightening screw.

According to some embodiments in the first aspect of the disclosure, the stereoscopic wound iron core includes three iron core posts, and at least one first upper platen assembly is provided at a side of each iron core post.

According to some embodiments in the first aspect of the disclosure, the plurality of upper platen assemblies include a plurality of second upper platen assemblies, and each of the second upper platen assemblies is configured for being correspondingly distributed at a side of one upper iron yoke of a stereoscopic wound iron core.

According to some embodiments in the first aspect of the disclosure, each of the second upper platen assemblies includes:
a second upper platen; and
a second upper holder block configured for being arranged between the second upper platen and the coil winding.

According to some embodiments in the first aspect of the disclosure, the stereoscopic wound iron core includes three upper iron yokes, and at least one second upper platen assembly is provided at a side of each upper iron yoke.

According to some embodiments in the first aspect of the disclosure, the clamping device further includes:
a lower iron yoke insulating member configured for being arranged between the lower frame and the coil winding.

In a second aspect, an embodiment of the disclosure provides a transformer, and the transformer includes the clamping device according to any one of the embodiments in the first aspect.

The transformer according to the embodiment of the disclosure in the second aspect at least has the following beneficial effects.

The transformer of the technical theme of the disclosure includes the clamping device according to any one of the embodiments in the first aspect, the clamping device includes the lower frame, the plurality of upper platen assemblies and the plurality of screw assemblies, wherein the lower frame is configured for being arranged at the lower sides of the plurality of coil windings of the stereoscopic wound iron core transformer, the upper platen assemblies are configured for being distributed at the upper sides of the plurality of coil windings, and the lower frame and the upper platen assemblies are connected through the screw assemblies, so as to clamp the coil windings together. Since the clamping device is used in the transformer provided by the embodiments of the disclosure, compared with a traditional clamping device, steel consumables around an iron core are reduced, so that the transformer has a simpler structure, a smaller overall occupied volume, a lower weight, which can save materials and reduce stray loss of the transformer.

### BRIEF DESCRIPTION OF THE DRAWINGS

The accompanying drawings are provided to further understand the technical themes of the disclosure and constitute a part of the specification, and the accompanying drawings are used together with the embodiments of the disclosure to explain the technical themes of the disclosure, but do not constitute a limitation to the technical themes of the disclosure.

FIG. 1 is a front structural diagram of a transformer provided by an embodiment of the disclosure; and

FIG. 2 is a top structural diagram of the transformer provided by the embodiment of the disclosure.

### REFERENCE NUMERALS IN THE DRAWINGS

10 refers to stereoscopic wound iron core, 20 refers to coil winding, 30 refers to clamping device,
11 refers to iron yoke, 12 refers to iron core post, 111 refers to upper iron yoke, 112 refers to lower iron yoke,
31 refers to lower frame, 32 refers to upper platen assembly, 33 refers to screw assembly,
321 refers to first upper platen assembly, 3211 refers to first upper platen, 3212 refers to first upper holder block,
322 refers to second upper platen assembly, 3221 refers to second upper platen, 3222 refers to second upper holder block,
331 refers to first screw assembly, 3311 refers to first tightening screw, 3312 refers to first fastening nut, 3313 refers to lifting member,
332 refers to second screw assembly, 3321 refers to second tightening screw, 3322 refers to second fastening nut, and
311 refers to lower iron yoke insulating member.

### DETAILED DESCRIPTION

The embodiments of the disclosure are described in detail hereinafter, and examples of the embodiments are shown in the accompanying drawings, wherein the same or similar reference numerals throughout the accompanying drawings denote the same or similar elements or elements having the same or similar functions. The embodiments described hereinafter with reference to the accompanying drawings are exemplary, and are only intended to explain the disclosure, but should not be understood as limiting the disclosure.

It should be understood that in the description of the disclosure, the orientation or position relation related to the orientation description, such as the orientation or position relation indicated by “upper”, “lower”, “front”, “rear”, “left”, “right”, etc., is based on the orientation or position relation shown in the drawings, which is only used for convenience of description of the disclosure and simplification of description instead of indicating or implying that the indicated device or element must have a specific orientation, and be constructed and operated in a specific orientation, and thus should not be understood as a limitation to the disclosure.

In the description of the disclosure, if there are descriptions of “first” and “second”, it is only for the purpose of distinguishing between technical features, and should not be understood as indicating or implying relative importance, implicitly indicating the number of the indicated technical features or implicitly indicating the order of the indicated technical features.

In the description of the disclosure, unless otherwise clearly defined, terms such as “setting”, “mounting”, “connection”, etc., should be understood broadly, and those skilled in the art can reasonably determine the specific meanings of the above terms in the disclosure in combination with the specific contents of the technical themes. Those of ordinary skills in the art should realize that “connection” described in the embodiments of the disclosure includes direct connection and indirect connection through an intermediate part.

In the description of the disclosure, “at least one” refers to being one or more, and “multiple” refers to being two or more. “And/or” describes the relationship between related objects, and indicates that there may be three relationships. For example, A and/or B may indicate that A exists alone, A and B exist at the same time, and B exists alone. A and B may be singular numbers or plural numbers. The symbol “/” generally indicates that there is a relationship of “or” between the related objects. “At least one of” and similar expressions refer to any combination of the items followed, including any combination of singular or plural items. For example, at least one of a, b and c may indicate: a; b; c; a and b; a and c; b and c; or a and b and c; wherein a, b and c may be provided in singular or in plural.

The stereoscopic wound iron core transformer is used more and more widely due to the advantages of excellent performance, low no-load loss and low noise level.

In the related art, a stereoscopic wound iron core transformer is usually provided with a clamping device, which is used for supporting coil windings during assembly and operation of the transformer, so as to avoid the coil windings from displacement to affect performance of the transformer, thus increasing no-load loss and noise.

A traditional clamping device mainly includes an upper clamping member and a lower clamping member which are generally regular triangular frames. The upper clamping member and the lower clamping member are formed by welding steel plates or section steels. The upper clamping member and the lower clamping member form a whole around a contour line of an iron core, and the upper clamping member and the lower clamping member are connected through a plurality of screw assemblies, with a large occupied volume, a high weight and a lot of steel consumables used for manufacturing. When there are a lot of steel consumables near the stereoscopic wound iron core, a stray loss of the transformer can also be increased.

At present, the upper and lower clamping members with a Y-shaped structure are also used, but it is difficult to ensure that upper/lower end faces of a plurality of coil windings of the transformer are all at the same height due to influences of mounting deviation and transportation vibration. In this case, use of the clamping members with the Y-shaped structure may cause a problem that pressures on the coil windings are uneven, so that tight pressing of each coil winding cannot be ensured.

On this basis, the embodiments of the disclosure provide a clamping device of a stereoscopic wound iron core transformer and a transformer, which can reduce a volume and a weight of the clamping device, and save consumables.

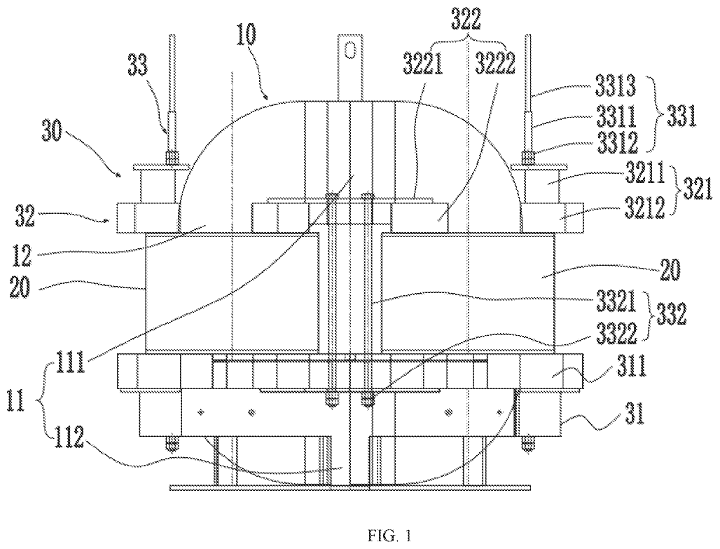

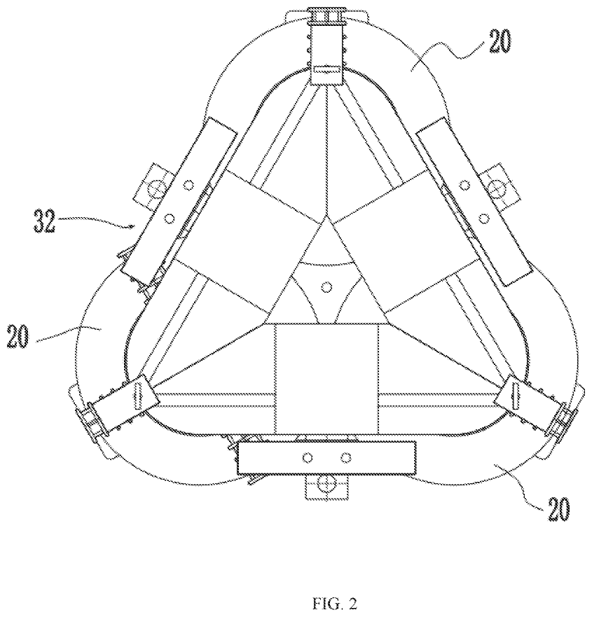

FIG. 1 and FIG. 2 show a transformer provided by an embodiment of the disclosure. The transformer shown in FIG. 1 is a stereoscopic wound iron core transformer, which includes a stereoscopic wound iron core 10, a coil winding 20 and a clamping device 30.

As shown in FIG. 1 and FIG. 2, the stereoscopic wound iron core 10 according to the embodiment of the disclosure includes a plurality of iron yokes 11 and a plurality of iron core posts 12. Specifically, three iron core posts 12 are provided, and the three iron core posts 12 are arranged in a regular triangle. The iron yoke 11 includes an upper iron yoke 111 and a lower iron yoke 112, three upper iron yokes 111 and three lower iron yokes 112 are provided respectively, and two adjacent iron core posts 12 are connected through the upper iron yoke 111 and the lower iron yoke 112.

As shown in FIG. 1 and FIG. 2, three coil windings 20 are provided according to the embodiment of the disclosure, which are correspondingly an A-phase coil winding, a B-phase coil winding and C-phase coil winding. Each of the three-phase coil windings 20 are wound on a respective one of the three iron core posts 12. Specifically, each coil winding 20 includes a low-voltage coil winding and a high-voltage coil winding, and the high-voltage coil winding is wound outside the low-voltage coil winding.

As shown in FIG. 1 and FIG. 2, the clamping device 30 of the stereoscopic wound iron core transformer provided by the embodiment of the disclosure includes:
a lower frame 31, wherein the lower frame 31 is configured for being arranged at lower sides of the plurality of coil windings 20 of the stereoscopic wound iron core transformer;
a plurality of upper platen assemblies 32, wherein the upper platen assemblies 32 are configured for being distributed at upper sides of the plurality of coil windings 20; and
a plurality of screw assemblies 33, wherein the screw assemblies 33 are configured for connecting the lower frame 31 with the upper platen assemblies 32, so that the lower frame 31 and the upper platen assemblies 32 clamp the coil windings 20 together.

It can be understood that a frame member having a substantially triangular structure is used as the lower frame 31. Specifically, the lower frame 31 is assembled at a lower side of each of the coil windings 20, and attached to an end face at a bottom of each of the coil windings 20.

It can be understood that the plurality of upper platen assemblies 32 is distributed at the upper sides of the three-phase coil windings 20. Specifically, the upper side of each coil winding 20 is provided with at least one upper platen assembly 32 respectively. Therefore, for each coil winding the coil winding 20 is clamped through the upper platen assembly 32 distributed on the coil winding 20 and the lower frame 31 together.

It can be understood that each upper platen assembly 32 is provided with a first through hole, the lower frame 31 is provided with a plurality of second through holes, and each of the plurality of second through holes corresponds to the first through hole in the respective upper platen assembly 32. The lower frame 31 is connected with the upper platen assemblies 32 by penetrating the screw assemblies 33 through the first through holes and the second through holes, so that the lower frame 31 and the upper platen assemblies 32 clamp the coil windings 20 together.

By replacing the traditional frame-type upper clamping member with a plurality of upper platen assemblies 32 in the clamping device 30 provided by the embodiment of the disclosure, compared with a traditional clamping device 30, steel consumables around an iron core can be reduced, so that the device has a simpler structure, a smaller overall occupied volume, a lower weight, and materials for manufacturing the clamping device 30 can be saved. Moreover, the steel consumables around the iron core are reduced, which is also beneficial for reducing a stray loss of the transformer.

In addition, the upper platen assemblies 32 according to the embodiment of the disclosure are independent of each other, and compared with an integrated Y-shaped structure frame, can apply pressures to the coil windings 20 without being affected by inconsistent heights of end faces of the phase coil windings 20, thus enhancing fastening of the coil windings 20.

It can be understood that the plurality of upper platen assemblies 32 include a first upper platen assembly 321 and/or a second upper platen assembly 322.

It can be understood that a plurality of first upper platen assemblies 321 are provided, and each first upper platen assembly 321 is correspondingly distributed at a side of one iron core post 12 of the stereoscopic wound iron core 10.

Specifically, a side of each iron core post 12 of the transformer is provided with at least one first upper platen assembly 321. Therefore, it is ensured that each coil winding 20 is provided with at least one first upper platen assembly 321, and each first upper platen assembly 321 independently applies a pressure to the corresponding coil winding 20 without being affected by other first upper platen assemblies 321, so that it is ensured that each coil winding 20 can be clamped tightly. Certainly, the specific number of the first upper platen assemblies 321 is not limited according to the embodiment of the disclosure.

For example, as shown in FIG. 2, three first upper platen assemblies 321 are provided, and the three first upper platen assemblies 321 are distributed in a triangle, and correspondingly arranged at sides of three iron core posts 12. In specific application, the first upper platen assembly 321 may be attached to an outside surface of the corresponding iron core post 12.

It can be understood that a plurality of second upper platen assemblies 322 are provided, and each second upper platen assembly 322 is correspondingly distributed at a side of one upper iron yoke 111 of the stereoscopic wound iron core 10.

Specifically, in order to clamp the phase coil windings 20, a side of each upper iron yoke 111 is provided with at least one second upper platen assembly 322. Certainly, a specific number of the second upper platen assemblies 322 is not limited according to the embodiment of the disclosure.

For example, as shown in FIG. 2, three second upper platen assemblies 322 are provided, and the three second upper platen assemblies 322 are distributed in a Y shape, and correspondingly arranged at sides of three upper iron yokes 111. In specific application, the second upper platen assembly 322 may be attached to an outside surface of the corresponding upper iron yoke 111, and tightly presses two adjacent coil windings 20 at the same time.

As an example, the first upper platen assembly 321 may include:
a first upper platen 3211; and
a first upper holder block 3212 configured for being arranged between the first upper platen 3211 and the coil winding 20.

As shown in FIG. 1, the first upper platen 3211 is arranged on the first upper holder block 3212, and the first upper holder block 3212 is attached to an upper end face of the coil winding 20. Therefore, the first upper platen 3211 applies a pressure to the coil winding 20 through the first upper holder block 3212.

It can be understood that the plurality of screw assemblies 33 includes a plurality of first screw assemblies 331, the first screw assemblies 331 are configured for connecting the first upper platen assemblies 321 with the lower frame 31, and the first screw assembly 331 includes a first tightening screw 3311 and a first fastening nut 3312.

Herein, the first upper platen 3211 is matched with the lower frame 31 to clamp the coil winding 20 through the first upper holder block 3212 and the first screw assembly 331. During specific implementation, it is ensured that the corresponding coil winding 20 receives sufficient clamping force by tightening the first screw assembly 331.

The first screw assembly 331 may further include a lifting member 3313 arranged at a top of the first tightening screw 3311. Illustratively, the lifting member 3313 may be a lifting plate. When lifting the stereoscopic wound iron core 10 transformer, the transformer may be lifted through lifting members 3313 on a plurality of first tightening screws 3311.

As an example, the second upper platen assembly 322 includes:
a second upper platen 3221; and
a second upper holder block 3222 configured for being arranged between the second upper platen 3221 and the coil winding 20.

It can be understood that the plurality of screw assemblies 33 includes a plurality of second screw assemblies 332, the second screw assemblies 332 are configured for connecting the second upper platen assemblies 322 with the lower frame 31, and the second screw assembly 332 includes a second tightening screw 3321 and a second fastening nut 3322.

As shown in FIG. 1, each second upper platen assembly 322 may be connected with the lower frame 31 through two or more second screw assemblies 332 to improve reliability of connection.

Herein, the second upper platen 3221 is matched with the lower frame 31 to clamp two adjacent coil windings 20 through the second upper holder block 3222 and the second screw assembly 332. During specific implementation, it is ensured that the corresponding two coil windings 20 receive sufficient clamping force by tightening the second screw assembly 332.

It can be understood that in order to reduce an influence of the steel lower frame 31 on performance of the coil winding 20, the clamping device 30 further includes a lower iron yoke insulating member 311, and the lower iron yoke insulating member 311 is configured for being arranged between the lower frame 31 and the coil winding 20.

The embodiments of the disclosure are described in detail with reference to the accompanying drawings above, but the disclosure is not limited to the above embodiments, and various changes may also be made within the knowledge scope of those of ordinary skills in the art without departing from the purpose of the disclosure.

1. A clamping device of a stereoscopic wound iron core transformer, comprising:
a lower frame, wherein the lower frame is configured for being arranged at lower sides of a plurality of coil windings of the stereoscopic wound iron core transformer;
a plurality of upper platen assemblies, wherein the plurality of upper platen assemblies are configured for being distributed at upper sides of the plurality of coil windings; and
a plurality of screw assemblies, wherein the screw assemblies are configured for connecting the lower frame with the upper platen assemblies, so that the lower frame and the upper platen assemblies clamp the coil windings together.

2. The clamping device of claim 1, wherein the plurality of upper platen assemblies comprise a plurality of first upper platen assemblies, and each of the first upper platen assemblies is configured for being correspondingly distributed at a side of one iron core post of a stereoscopic wound iron core.

3. The clamping device of claim 2, wherein each of the first upper platen assemblies comprises:
a first upper platen; and
a first upper holder block configured for being arranged between the first upper platen and the coil winding.

4. The clamping device of claim 2, wherein the plurality of screw assemblies comprise a plurality of first screw assemblies, each of the first screw assemblies is configured for connecting a respective one of the first upper platen assemblies with the lower frame and comprises a first tightening screw and a first fastening nut, wherein a lifting member is provided at a top of the first tightening screw.

5. The clamping device of claim 2, wherein the stereoscopic wound iron core comprises three iron core posts, and at least one first upper platen assembly is provided at a side of each iron core post.

6. The clamping device of claim 1, wherein the plurality of upper platen assemblies comprise a plurality of second upper platen assemblies, and each of the second upper platen assemblies is configured for being correspondingly distributed at a side of one upper iron yoke of a stereoscopic wound iron core.

7. The clamping device of claim 6, wherein each of the second upper platen assemblies comprises:
a second upper platen; and
a second upper holder block configured for being arranged between the second upper platen and the coil winding.

8. The clamping device of claim 6, wherein the stereoscopic wound iron core comprises three upper iron yokes, and at least one second upper platen assembly is provided at a side of each upper iron yoke.

9. The clamping device of claim 1, further comprising:
a lower iron yoke insulating member configured for being arranged between the lower frame and the coil winding.

10. A transformer, comprising a clamping device of comprising:
a lower frame, wherein the lower frame is configured for being arranged at lower sides of a plurality of coil windings of the stereoscopic wound iron core transformer;
a plurality of upper platen assemblies, wherein the plurality of upper platen assemblies are configured for being distributed at upper sides of the plurality of coil windings; and
a plurality of screw assemblies, wherein the screw assemblies are configured for connecting the lower frame with the upper platen assemblies, so that the lower frame and the upper platen assemblies clamp the coil windings together.

11. The transformer of claim 10, wherein the plurality of upper platen assemblies comprise a plurality of first upper platen assemblies, and each of the first upper platen assemblies is configured for being correspondingly distributed at a side of one iron core post of a stereoscopic wound iron core.

12. The transformer of claim 11, wherein each of the first upper platen assemblies comprises:
a first upper platen; and
a first upper holder block configured for being arranged between the first upper platen and the coil winding.

13. The transformer of claim 11, wherein the plurality of screw assemblies comprise a plurality of first screw assemblies, each of the first screw assemblies is configured for connecting a respective one of the first upper platen assemblies with the lower frame and comprises a first tightening screw and a first fastening nut, wherein a lifting member is provided at a top of the first tightening screw.

14. The transformer of claim 11, wherein the stereoscopic wound iron core comprises three iron core posts, and at least one first upper platen assembly is provided at a side of each iron core post.

15. The transformer of claim 10, wherein the plurality of upper platen assemblies comprise a plurality of second upper platen assemblies, and each of the second upper platen assemblies is configured for being correspondingly distributed at a side of one upper iron yoke of a stereoscopic wound iron core.

16. The transformer of claim 15, wherein each of the second upper platen assemblies comprises:
a second upper platen; and
a second upper holder block configured for being arranged between the second upper platen and the coil winding.

17. The transformer of claim 15, wherein the stereoscopic wound iron core comprises three upper iron yokes, and at least one second upper platen assembly is provided at a side of each upper iron yoke.

18. The transformer of claim 10, wherein the clamping device further comprises:
a lower iron yoke insulating member configured for being arranged between the lower frame and the coil winding.
